(19) United States
(12) Patent Application Publication
(10) Pub. No.: US 2025/0095224 A1
(43) Pub. Date: Mar. 20, 2025

(54) GENERATIVE VIRTUAL BACKGROUNDS FOR VIDEO CONFERENCING

(71) Applicant: GOOGLE LLC, Mountain View, CA (US)

(72) Inventors: Megha Malpani, San Francisco, CA (US); Ameet Jani, Campbell, CA (US); Kejia Shao, Santa Clara, CA (US); Ryosuke Matsumoto, Dublin, CA (US); Nikhil Siva Subash, San Jose, CA (US)

(21) Appl. No.: 18/468,624

(22) Filed: Sep. 15, 2023

(51) Int. Cl. G06T 11/00; G06F 40/40

(52) U.S. Cl. CPC G06T 11/00; G06F 40/40; G06T 2200/24

(57) ABSTRACT

A video conferencing system may receive, via a user interface of a video conferencing application, a user prompt for a virtual background in a video conference. A video conferencing system may generate a first prompt from the user prompt, the first prompt including an instruction to create a second prompt based on the user prompt. A video conferencing system may receive the second prompt from a text-to-text language model. A video conferencing system may provide the second prompt as an input to an image generation model. A video conferencing system may receive a generated image from the image generation model. A video conferencing system may apply the generated image as the virtual background.

### BACKGROUND

Users may select an image to use as a virtual background in a video conference. Some conventional video conferencing applications provide only a limited number of background images that can be selected by the user for use as a virtual background.

### SUMMARY

In some aspects, the techniques described herein relate to a non-transitory computer-readable medium storing executable instructions that when executed by at least one processor cause the at least one processor to execute operations, the operations including: receiving, via a user interface of a video conferencing application, a user prompt for a virtual background in a video conference; generating a first prompt from the user prompt, the first prompt including an instruction to create a second prompt based on the user prompt; receiving the second prompt from a text-to-text language model; providing the second prompt as an input to an image generation model; receiving a generated image from the image generation model; and applying the generated image as the virtual background.

In some aspects, the techniques described herein relate to an apparatus including: at least one processor; and a non-transitory computer-readable medium storing executable instructions that cause the at least one processor to: receive, via a user interface of a video conferencing application, a user prompt for a virtual background in a video conference; generate a first prompt from the user prompt, the first prompt including an instruction to create a second prompt based on the user prompt; receive the second prompt from a text-to-text language model; provide the second prompt as an input to an image generation model; receive a generated image from the image generation model; and apply the generated image as the virtual background.

In some aspects, the techniques described herein relate to a method including: receiving, via a user interface of a video conferencing application, a user prompt for a virtual background in a video conference; generating a first prompt from the user prompt, the first prompt including an instruction to create a second prompt based on the user prompt; receiving the second prompt from a text-to-text language model; providing the second prompt as an input to an image generation model; receiving a generated image from the image generation model; and applying the generated image as the virtual background.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a video conferencing system for generating an artificial intelligence (AI)-generated image for a virtual background according to an aspect.

FIG. 1B illustrates an example of the video conferencing system with a user device and one or more server computers according to an aspect.

FIG. 1C illustrates an example of a prompt generated by a video conferencing application according to an aspect.

FIG. 1D illustrates an example of a prompt that is provided to an image generation model according to an aspect.

FIG. 2 illustrates examples of prompts and images generated by the video conferencing system according to an aspect.

FIG. 3 illustrates examples of prompts and images generated by the video conferencing system according to another aspect.

FIGS. 4A through 4C illustrate an example user interface for submitting a user prompt to create an AI-generated image according to an aspect.

FIG. 5 illustrates a flowchart depicting example operations of the video conferencing system according to an aspect.

### DETAILED DESCRIPTION

This disclosure relates to a video conferencing application with a background creation engine configured to use a text-to-text language model to convert a user prompt (e.g., “create a background of an ocean with sailboats”) to a detailed, specialized prompt configured for virtual background generation for use in a video call. The background creation engine may generate a first prompt based on the user prompt and include an instruction to create a second prompt for an image generation model. The background creation engine may provide the first prompt to the text-to-text language model and then receive the second prompt from the text-to-text language model. The background creation engine may provide the second prompt to the image generation model and then receive at least one AI-generated image. The video conferencing application may receive a user selection to an AI-generated image and apply the AI-generated image as the virtual background. Using the text-to-text language model as an intermediary to create a better prompt for image generation in a video conferencing scenario may provide better image results.

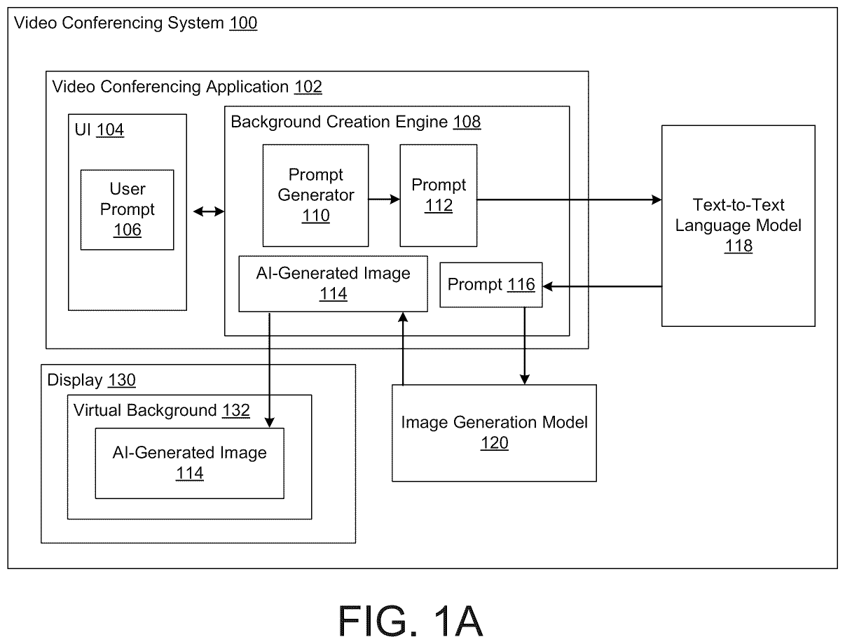

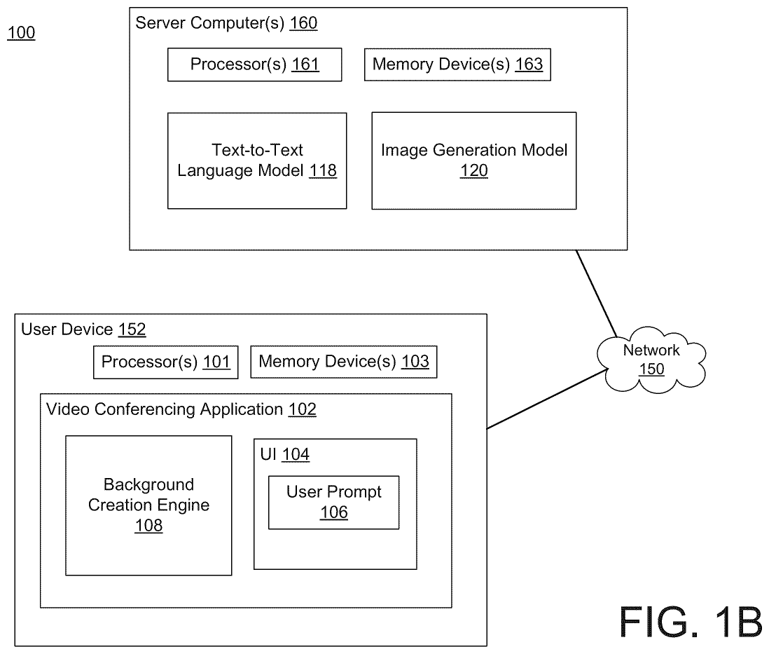

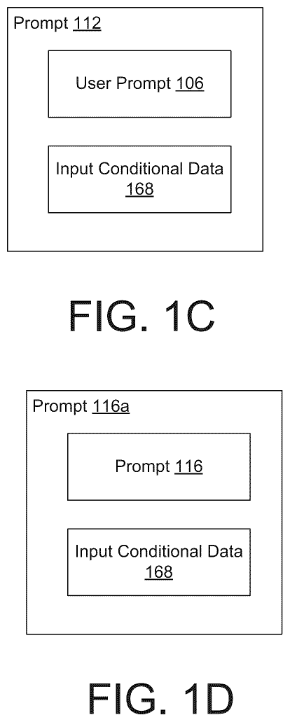

FIGS. 1A through 1C illustrate a video conferencing system 100 that uses a text-to-text language model 118 and an image generation model 120 to generate an AI-generated image 114 for use as a virtual background 132 in a video call.

The video conferencing system 100 includes a video conferencing application 102 configured to enable a user to join or establish a video call with one or more other users. According to the techniques discussed herein, the user may use the video conferencing application 102 to create an AI-generated image 114 and use the AI-generated image 114 as a virtual background 132 in a video call. The video conferencing application 102 may be a software program that allows users to have live video conversations with each other over the internet. The video conferencing application 102 may enable users in different locations to communicate face-to-face as if they were in the same room. The video conferencing application 102 may enable audio and video calling (e.g., users can see and hear each other in real time), screen sharing (e.g., users can share their screens with each other, so they can collaborate on projects or presentations), chat capabilities (e.g., users can send text messages to each other during the call), among other features. A virtual background 132 is a background image that is displayed behind the user in a video call. The virtual background 132 is used to hide the actual user's background, which may provide a more professional and/or interesting look.

Instead of restricting the user to select a set of predefined images (or images uploaded by the user), the video conferencing application 102 enables the user to create an AI-generated image 114 for use as a virtual background 132. The AI-generated image 114 may be a new and creative image generated by an image generation model 120. The video conferencing application 102 includes a user interface 104 that receives a user prompt 106 for creating a virtual background 132 in a video call. In some examples, the user interface 104 includes one or more settings about the virtual background 132. In some examples, the setting(s) may include an interface that enables the user to enter a user prompt 106 to create a new image by an image generation model 120 for use as a virtual background 132.

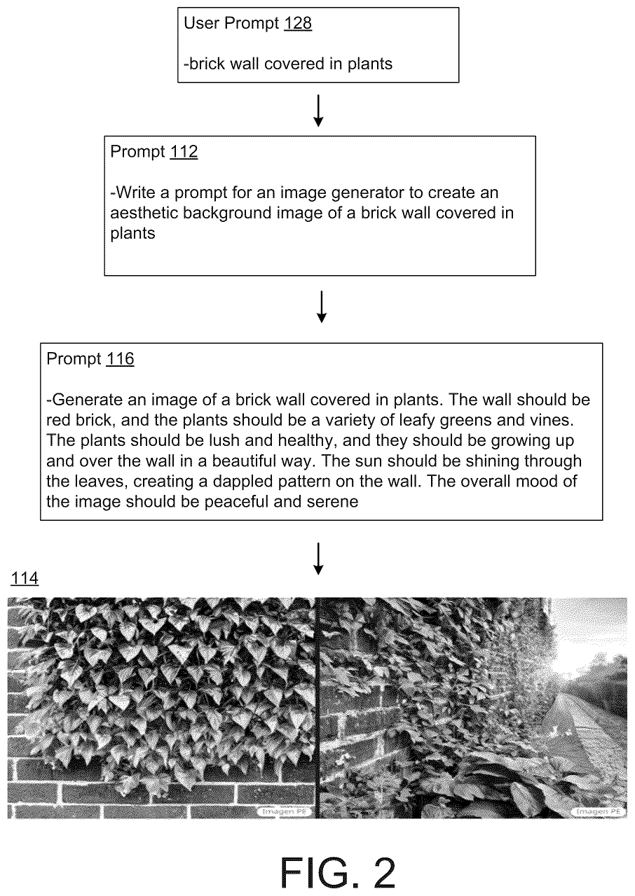

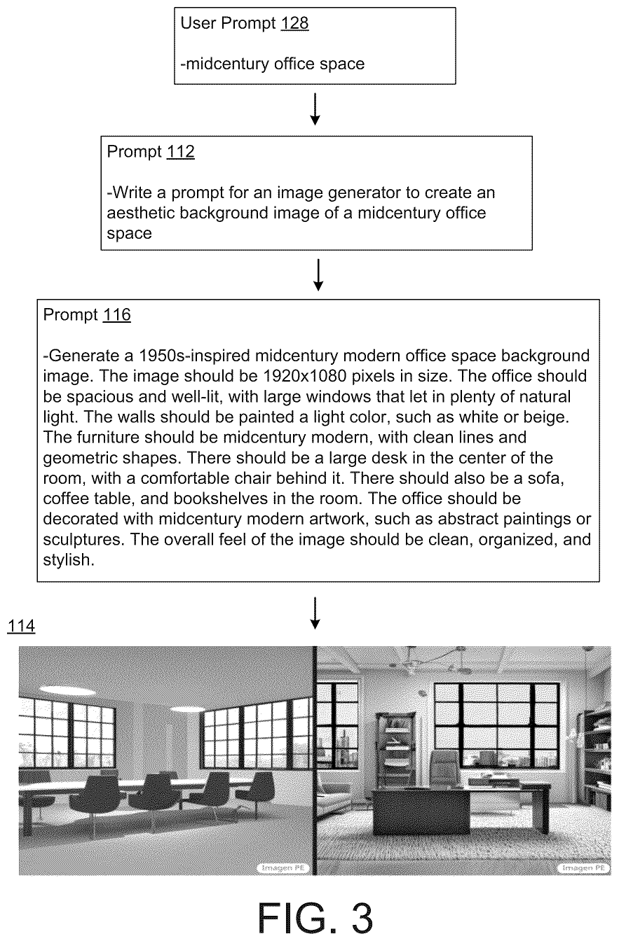

The user prompt 106 may include a short phrase, entered by the user, such as “brick wall covered in plants” (see FIG. 2) or “midcentury office space” (see FIG. 3). The user prompt 106 may include natural language text entered by the user. The user prompt 106 may include free form text. The video conferencing application 102 includes a background creation engine 108 configured to facilitate communication between the video conferencing application 102, the text-to-text language model 118, and the image generation model 120 to create enriched, creative images based on the user prompt 106. In some examples, as shown in FIG. 1B, a user device 152 may include or execute the video conferencing application 102. In some examples, the video conferencing application 102 may communicate with the text-to-text language model 118 and the video conferencing application 102 over a network 150.

The background creation engine 108 includes a prompt generator 110. The prompt generator 110 may receive the user prompt 106 via the user interface 104 and generate a prompt 112 (e.g., a first prompt) with an instruction to create a prompt (e.g., prompt 116) for an image generation model 120 using the user prompt 120. In some examples, the background creation engine 108 may validate the user prompt 106 by analyzing the user prompt 106 to determine whether the text entered by the user contains restricted content (e.g., offensive or inappropriate content). If the user prompt 106 is not validated, the background creation engine 108 may display an error message. In some examples, validation of the user prompt 106 is executed by the text-to-text language model 118.

The prompt 112 may include the user prompt 106. In some examples, the prompt 112 includes additional information inserted by the prompt generator 110. In some examples, the prompt 112 may include a request to create a prompt for an image generation model 120 using the user prompt 106. Referring to FIG. 2, the prompt 112 may include “write a prompt for an image generator to create an aesthetic background image of a brick wall covered in plants.” Referring to FIG. 3, the prompt 112 may include “write a prompt for an image generator to create an aesthetic background image of a midcentury office space.”

In some examples, as shown in FIG. 1C, the prompt 112 includes the user prompt 106 and input conditional data 168. The input conditional data 168 may include other information inserted by the prompt generator 110 to enable the text-to-text language model 118 to generate a prompt 116 for an image generation model 120 to create an AI-generated image 114 that is tailored to a video conference scenario and/or the user device 152. In some examples, the input conditional data 168 may include information to generate a prompt 116 with a user in the center of the virtual background 132 (e.g., design an image around the user, which is in the center of the image). For example, the input conditional data 168 may include information about the location of the user in an image. In some examples, the input condition data 168 may include display screen information about a user device 152 or a display 130 that is used by the virtual background 132. In some examples, the display screen information include resolution, color accuracy, contrast ratio, viewing angle, refresh rate, response time, brightness, size and display ratio, and/or panel technology (e.g., liquid crystal display (LCD), organic light-emitting diode (OLED), active-matrix organic light-emitting diode (AMOLED), etc.).

The background creation engine 108 may provide the prompt 112 as an input to the text-to-text language model 118. In some examples, the background creation engine 108 may transmit, over the network, the prompt 112 to the text-to-text language model 118. In some examples, as shown in FIG. 1B, the text-to-text language model 118 may execute on one or more server computers 160. In some examples, the text-to-text language model 118 may execute on the user device 152. In some examples, the text-to-text language model 118 is stored on an operating system of the user device 152. In response to the prompt 112, the text-to-text language model 118 may generate a prompt 116 (e.g., a second prompt) for the image generation model 120. The prompt 116, generated by the text-to-text language model 118, may include a more detailed description about the underlying user prompt 106.

FIG. 2 illustrates an example of a prompt 116 generated by the text-to-text language model 118 in response to a user prompt 128 (“brick wall covered in plants”). FIG. 2 depicts two different AI-generated images 114 from the same user prompt 128. FIG. 3 illustrates an example of another prompt 116 generated by the text-to-text language model 118 in response to a user prompt 128 (“midcentury office space”). FIG. 3 depicts two different AI-generated images 114 from the same user prompt 128. The text-to-text language model 118 may be a pre-trained large language model (LLM) (e.g., a neural network-based language model). In some examples, the text-to-text language model 118 is a LLM that is specifically trained to generate prompts 116 for an image generation model 120. The background creation engine 108 may receive the prompt 116 from the text-to-text language model 118. In some examples, the background creation engine 108 may receive, over the network 150, the prompt 116 from the text-to-text language model 118.

In response to receiving the prompt 116, the background creation engine 108 may provide the prompt 116 to the image generation model 120. In some examples, the background creation engine 108 may transmit, over the network 150, the prompt 116 to the image generation model 120. In some examples, as shown in FIG. 1B, the image generation model 120 may execute on one or more server computers 160 (e.g., the same server computer(s) 160 executing the text-to-text language model 118 or server computer(s) 160 different from the server computer(s) 160 executing the text-to-text language model 118). In some examples, the image generation model 120 may execute on the user device 152. In some examples, the image generation model 120 is stored on an operating system of the user device 152. In some examples, the text-to-text language model 118 may execute on the user device 152, and the image generation model 120 may execute on one or more server computer(s) 160. In some examples, the text-to-text language model 118 may provide the prompt 116 to the image generation model 120 (e.g., without involvement of the video conferencing application 102). In some examples, the prompt 112 may include information about a location of an image generation model 120, and the text-to-text language model 118 may transmit the prompt 116 directly to the image generation model 120.

In response to the prompt 116, the image generation model 120 may generate one or more AI-generated images 114 and may provide the AI-generated images 114 to the background creation engine 108. An image generation model 120 is a type of machine learning model that can create novel and creative images from text descriptions. The image generation model 120 may be trained to learn the relationship between text and images from a large dataset of paired images and text descriptions. In some examples, the image generation model 120 is a pre-trained text-to-image model. In some examples, the image generation model 120 is a text-to-image model that is specifically trained to generate images for a virtual background 132.

Referring to FIG. 1D, in some examples, the prompt generator 110 may generate a prompt 116a (e.g., a third prompt) that includes the prompt 116 generated by the text-to-text language model 118, where the prompt 116a is provided to the image generation model 120. In some examples, the prompt 116a includes additional information inserted by the prompt generator 110. In some examples, the prompt 116a includes the input conditional data 168. For example, instead of including the input condition data 168 in the prompt 112 provided to the text-to-text language model 118, the prompt generator 110 includes the input condition data 168 into the prompt 116a, which is sent to the image generation model 120. In other words, the prompt generator 110 may combine the prompt 116 generated by the text-to-text language model 118 and the input conditional data 168. As indicated above, the input conditional data 168 may include display screen information about the display 130 and/or information indicating that the location of the user in the image (e.g., the user is in the center of the image).

In some examples, the input conditional data 168 may include an image of the user. In some examples, the image of the user is captured by one or more camera devices on the user device 152. The video conferencing application 102 may obtain an image of the user and include the image of the user in the prompt 116a that is provided to the image generation model 120. The image generation model 120 may use the prompt 116 generated by the text-to-text language model 118 and the user's image to create a novel image that accounts for the appearance of the user (e.g., the style and color of the user's clothes, any accessories worn by the user, etc.). In some examples, the image generation model 120 may be a mixed modality image generation model configured to receive both image data and textual data to generate an AI-generated image 114. In some examples, the prompt 112 includes a first portion of input conditional data 168, and the prompt 116 includes a second portion of input conditional data 168. In some examples, the input conditional data 168 in the prompt 112 may include information about the location of the user in the video. In some examples, the input conditional data 168 in the prompt 116 may include display screen characteristics.

In some examples, the background creation engine 108 may receive, over the network 150, the AI-generated images 114 from the image generation model 120. By using the text-to-text language model 118 as an intermediary to create a more detailed prompt (e.g., prompt 116), AI-generated images 114 may be generated in a manner that is more suitable for use as a virtual background 132, as shown in FIGS. 2 and 3. In some examples, the video conferencing application 102 may provide the AI-generated image(s) 114 for display on the user interface 104 for selection by the user. In response to a selection to an AI-generated image 114, the video conferencing application 102 may apply the AI-generated image 114 as the virtual background 132. In some examples, the video conferencing application 102 may store the AI-generated images on the user device 152, which can be later retrieved by the user. In some examples, the video conferencing application 102 may provide one or more UI controls that enables the user to export, transmit, or copy the AI-generated images 114 to other locations and/or applications.

The video conferencing application 102 may be any type of video conferencing application executable by a user device 152. In some examples, the video conferencing application 102 is a native application, which can be installed on an operating system of the user device 152. In some examples, the video conferencing application 102 is a system application (e.g., an operating system application). In some examples, the video conferencing application 102 is a sub-component of the operating system of the user device 152. In some examples, the video conferencing application 102 is a website or webpage executable by a browser application of the user device 152. The browser application is a web browser configured to render browser tabs in the context of one or more browser windows. In some examples, the video conferencing application 102 is a web application. A web application may be an application program that is stored on a remote server (e.g., a web server) and delivered over the network 150 through the browser application.

In some examples, the image generation model 120 includes a controllable diffusion model. In some examples, the controllable diffusion model is a specifically configured machine-learning (ML) model that has been trained to learn one or more input conditions as specified by the input conditional data 168 (e.g., the display screen information). In some examples, the input condition data 168 may include information about one or more input conditions (or controls) for generating images from the controllable diffusion model. The input condition(s) are provided to the controllable diffusion model as input(s) that influence generation of the AI-generated image 114. In some examples, the input condition(s) include one or more task-specific input condition(s) that are learned by the controllable diffusion model during a training period.

In some examples, a controllable diffusion model includes a neural network configured to control diffusion models using the input conditional data 168. In some examples, the controllable diffusion model may include a locked neural network block and a trainable neural network block, where the weights of the locked neural network block are copied and transferred to the trainable neural network block. The locked neural network block may represent a large pre-trained text-to-image ML model. The trainable neural network block and locked neural network block are connected with a convolution layer and a convolution layer, where the convolution weights progressively grow from zeros to optimized parameters in a learned manner. In some examples, the convolution layer includes a 1×1 convolution. In some examples, the convolution layer includes a 1×1 convolution with weight and bias initialized as zeroes. The trainable neural network block is trained using training input condition data (e.g., the input conditional data 168) to learn the input condition(s) (e.g., the display screen information) and the locked neural network block may preserve the weights of the neural network.

The user device 152 may be any type of computing device that includes one or more processors 101, one or more memory devices 103 and a display 130. In some examples, the user device 152 is a laptop computer. In some examples, the user device 152 is a desktop computer. In some examples, the user device 152 is a tablet computer. In some examples, the user device 152 is a smartphone. In some examples, the user device 152 is a wearable device. In some examples, the display 130 is the display of the user device 152. In some examples, the display 130 may also include one or more external monitors that are connected to the user device 152.

The processor(s) 101 may be formed in a substrate configured to execute one or more machine executable instructions or pieces of software, firmware, or a combination thereof. The processor(s) 101 can be semiconductor-based—that is, the processors can include semiconductor material that can perform digital logic. The memory device(s) 103 may include a main memory that stores information in a format that can be read and/or executed by the processor(s) 101. The memory device(s) 103 may store the background creation engine 108. In some examples, the memory device(s) 103 may store the text-to-text language model 118. In some examples, the memory device(s) 103 may store the image generation model 120. In some examples, the memory device(s) 103 includes a non-transitory computer-readable medium that includes executable instructions that cause at least one processor (e.g., the processor(s) 101) to execute operations discussed with reference to the video conferencing system 100.

The server computer(s) 160 may be computing devices that take the form of a number of different devices, for example a standard server, a group of such servers, or a rack server system. In some examples, the server computer(s) 160 may be a single system sharing components such as processors and memories. In some examples, the server computer(s) 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within network 150. Network 150 may further include any number of hardwired and/or wireless connections. In some examples, the server computer(s) 160 stores the text-to-text language model 118. In some examples, the server computer(s) 160 stores the image generation model 120.

The server computer(s) 160 may include one or more processors 161 formed in a substrate, an operating system (not shown) and one or more memory devices 163. The memory device(s) 163 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 161 may be formed in a substrate configured to execute one or more machine executable instructions or pieces of software, firmware, or a combination thereof. The processor(s) 161 can be semiconductor-based—that is, the processors can include semiconductor material that can perform digital logic. The memory device(s) 163 may store information in a format that can be read and/or executed by the processor(s) 161. In some examples, the memory device(s) 163 includes a non-transitory computer-readable medium that includes executable instructions that cause at least one processor (e.g., the processor(s) 161) to execute operations discussed with reference to the video conferencing system 100.

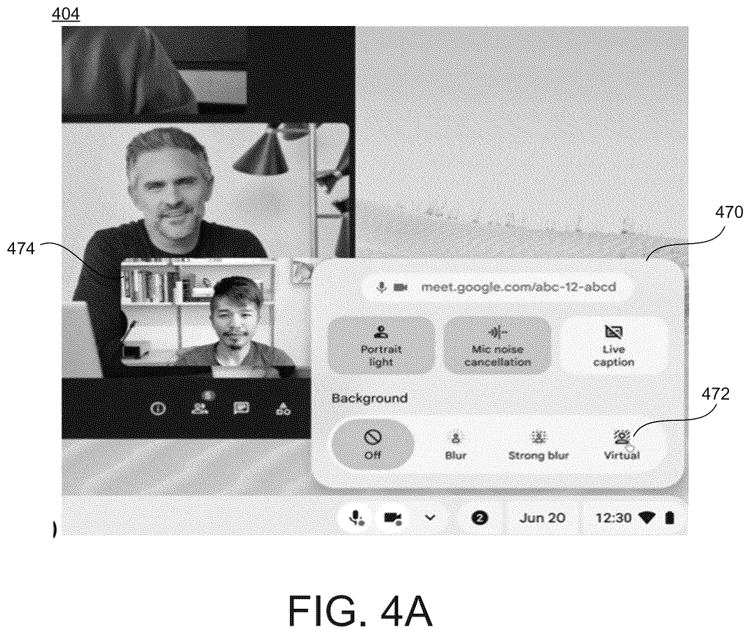

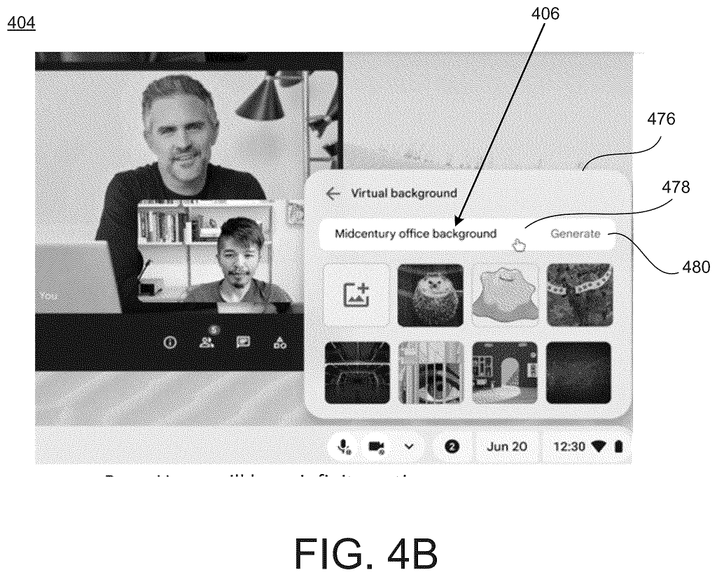

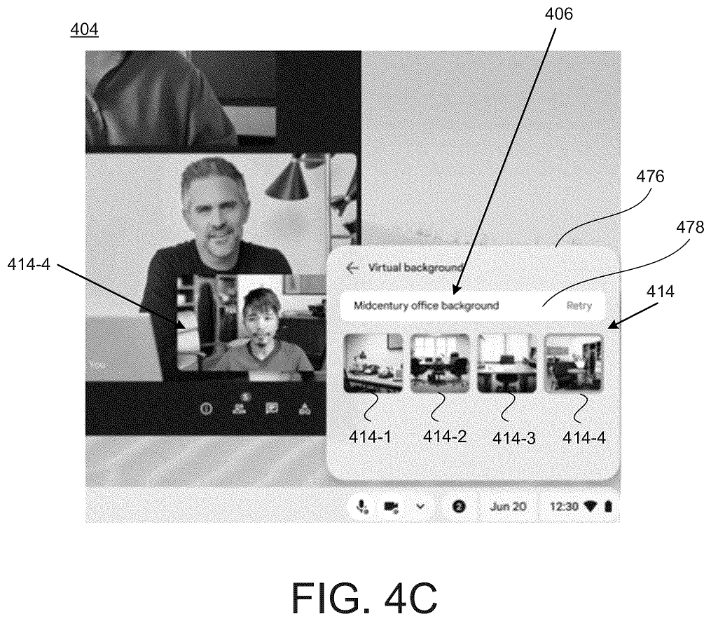

FIGS. 4A to 4C illustrate example user interfaces 404 of a video conferencing application. In some examples, the user interface 404 is provided by the video conferencing system 100 of FIGS. 1A to 1C and may include any of the details discussed with reference to those figures. Referring to FIG. 4A, a video conferencing application (e.g., the video conferencing application 102 of FIGS. 1A to 1C) may initiate display of a user interface 404 of a video call. The user interface 404 includes a video 474 of the user, as well as video from other participants that joined the video call. In response to a selection to a UI control, the video conferencing application may display a UI object 470 that includes one or more controls about the user's background during the video call. In some examples, the UI object 470 includes a selectable element 472 (e.g., “virtual”), which, when selected, causes the video conferencing application to display a UI object 476, as shown in FIG. 4B.

The UI object 476 includes a data entry field 478 that enables the user to enter a user prompt 406 (e.g., “Midcentury office background”). The data entry field 478 may enable the user to enter any type of natural language description about which virtual background to create by an AI-generated image. In response to selection of a UI element 480 (e.g., generate), the video conferencing application may cause the generation of a plurality of AI-generated images 414 according to the techniques discussed with reference to FIGS. 1A to 1C and FIGS. 2-3. The video conferencing application may display the AI-generated images 414 in the UI object 476. As shown in FIG. 4C, the AI-generated images 414 may include an AI-generated image 414-1, an AI-generated image 414-2, an AI-generated image 414-3, and an AI-generated image 414-4. In response to selection to an AI-generated image 414-4, the video conferencing application may apply the AI-generated image 414-4 as the virtual background, as shown in FIG. 4C.

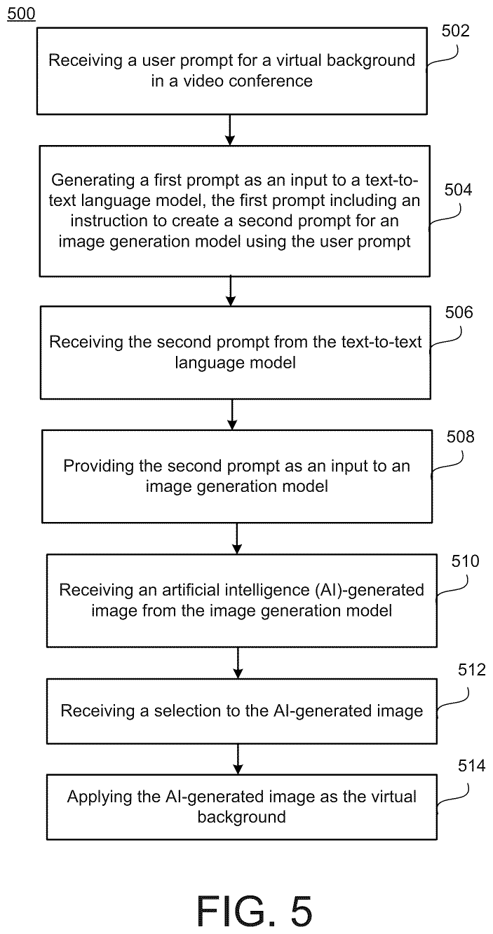

FIG. 5 is a flowchart 500 depicting example operations of a video conferencing system that uses a text-to-text language model to convert a user prompt (e.g., “create a background of an ocean with sailboats”) to a detailed, specialized prompt configured for virtual background generation in a video conferencing scenario. The video conferencing system may generate a first prompt with an instruction to create a second prompt for an image generation model using the user prompt. The video conferencing system may provide the first prompt to the text-to-text language model and then receive the second prompt from the text-to-text language model. The video conferencing system may provide the second prompt to the image generation model and then receive at least one AI-generated image. The video conferencing system may receive a user selection to an AI-generated image and apply the AI-generated image as the virtual background. Using the text-to-text language model as an intermediary to create a better prompt for image generation in a video conferencing scenario may provide better image results for a virtual background in a video call.

The flowchart 500 may depict operations of a computer-implemented method. The flowchart 500 is explained with respect to the virtual conferring system 100 of FIGS. 1A to 1C and may include any of the details discussed with reference to those figures. Although the flowchart 500 of FIG. 5 illustrates the operations in sequential order, it will be appreciated that this is merely an example, and that additional or alternative operations may be included. Further, operations of FIG. 5 and related operations may be executed in a different order than that shown, or in a parallel or overlapping fashion.

Operation 502 includes receiving a user prompt for a virtual background in a video conference. Operation 504 includes generating a first prompt as an input to a text-to-text language model, the first prompt including an instruction to create a second prompt for an image generation model using the user prompt. Operation 506 includes receiving the second prompt from the text-to-text language model. Operation 508 includes providing the second prompt as an input to an image generation model. Operation 510 includes receiving an artificial intelligence (AI)-generated image from the image generation model. Operation 512 includes receiving a selection to the AI-generated image. Operation 514 includes applying the AI-generated image as the virtual background.

Clause 1. A non-transitory computer-readable medium storing executable instructions that when executed by at least one processor cause the at least one processor to execute operations, the operations comprising: receiving, via a user interface of a video conferencing application, a user prompt for a virtual background in a video conference; generating a first prompt from the user prompt, the first prompt including an instruction to create a second prompt based on the user prompt; receiving the second prompt from a text-to-text language model; providing the second prompt as an input to an image generation model; receiving a generated image from the image generation model; and applying the generated image as the virtual background.

Clause 2. The non-transitory computer-readable medium of clause 1, wherein the operations further comprise: initiating display of the generated image on the user interface; detecting a selection to the generated image; and in response to the selection of the generated image being detected, applying the generated image as the virtual background.

Clause 3. The non-transitory computer-readable medium of clause 1 or 2, wherein the generated image is a first generated image, the operations further comprising: initiating display of a user interface including a data entry field for receiving the user prompt; receiving the first generated image and a second generated image; initiating display of the first generated image and the second generated image on the user interface; detecting a selection of the first generated image; and applying the first generated image as the virtual background in response to detecting the selection.

Clause 4. The non-transitory computer-readable medium of any of clauses 1 to 3, wherein the operations further comprise: transmitting, over a network, the first prompt to the text-to-text language model.

Clause 5. The non-transitory computer-readable medium of any of clauses 1 to 4, wherein the operations further comprise: transmitting, over a network, the second prompt to the image generation model.

Clause 6. An apparatus comprising: at least one processor; and a non-transitory computer-readable medium storing executable instructions that cause the at least one processor to: receive, via a user interface of a video conferencing application, a user prompt for a virtual background in a video conference; generate a first prompt from the user prompt, the first prompt including an instruction to create a second prompt based on the user prompt; receive the second prompt from a text-to-text language model; provide the second prompt as an input to an image generation model; receive a generated image from the image generation model; and apply the generated image as the virtual background.

Clause 7. The apparatus of clause 6, wherein the executable instructions include instructions that cause the at least one processor to: initiate display of the generated image on the user interface; detect a selection to the generated image; and in response to the selection of the generated image being detected, apply the Generated image as the virtual background.

Clause 8. The apparatus of clause 6 or 7, wherein the generated image is a first generated image, wherein the executable instructions include instructions that cause the at least one processor to: initiate display of a user interface including a data entry field for receiving the user prompt; receive the first generated image and a second generated image from the image generation model; initiate display of the first generated image and the second generated image on the user interface; detect a selection to the first generated image; and apply the first generated image as the virtual background.

Clause 9. The apparatus of any of clauses 6 to 8, wherein the first prompt includes the user prompt and input conditional data.

Clause 10. The apparatus of clause 9, wherein the input conditional data includes display screen information.

Clause 11. The apparatus of any of clauses 6 to 10, wherein the executable instructions include instructions that cause the at least one processor to: generating a third prompt, the third prompt including the second prompt and input conditional data; and transmitting the third prompt to the image generation model.

Clause 12. The apparatus of clause 11, wherein the input conditional data includes display screen information.

Clause 13. The apparatus of any of clauses 6 to 12, wherein the image generation model includes a controllable diffusion model.

Clause 14. A method comprising: receiving, via a user interface of a video conferencing application, a user prompt for a virtual background in a video conference; generating a first prompt from the user prompt, the first prompt including an instruction to create a second prompt based on the user prompt; receiving the second prompt from a text-to-text language model; providing the second prompt as an input to an image generation model; receiving a generated image from the image generation model; and applying the generated image as the virtual background.

Clause 15. The method of clause 14, further comprising: initiating display of the generated image on the user interface; detecting a selection to the generated image; and in response to the selection of the generated image being detected, applying the generated image as the virtual background.

Clause 16. The method of clause 14 or 15, wherein the generated image is a first generated image, the method further comprising: initiating display of a user interface including a data entry field for receiving the user prompt; receiving the first generated image and a second generated image from the image generation model; initiating display of the first generated image and the second generated image on the user interface; detecting a selection to the first generated image; and applying the first generated image as the virtual background.

Clause 17. The method of any of clauses 14 to 16, further comprising: transmitting, over a network, the first prompt to the text-to-text language model.

Clause 18. The method of any of clauses 14 to 17, further comprising: transmitting, over a network, the second prompt to the image generation model.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A non-transitory computer-readable medium storing executable instructions that when executed by at least one processor cause the at least one processor to execute operations, the operations comprising:
receiving, via a user interface of a video conferencing application, a user prompt for a virtual background in a video conference;
generating a first prompt from the user prompt, the first prompt including an instruction to create a second prompt based on the user prompt;
receiving the second prompt from a text-to-text language model;
providing the second prompt as an input to an image generation model;
receiving a generated image from the image generation model; and
applying the generated image as the virtual background.

2. The non-transitory computer-readable medium of claim 1, wherein the operations further comprise:
initiating display of the generated image on the user interface;
detecting a selection to the generated image; and
in response to the selection of the generated image being detected, applying the generated image as the virtual background.

3. The non-transitory computer-readable medium of claim 1, wherein the generated image is a first generated image, the operations further comprising:
initiating display of a user interface including a data entry field for receiving the user prompt;
receiving the first generated image and a second generated image;
initiating display of the first generated image and the second generated image on the user interface;
detecting a selection of the first generated image; and
applying the first generated image as the virtual background in response to detecting the selection.

4. The non-transitory computer-readable medium of claim 1, wherein the operations further comprise:
transmitting, over a network, the first prompt to the text-to-text language model.

5. The non-transitory computer-readable medium of claim 1, wherein the operations further comprise:
transmitting, over a network, the second prompt to the image generation model.

6. An apparatus comprising:
at least one processor; and
a non-transitory computer-readable medium storing executable instructions that cause the at least one processor to:
receive, via a user interface of a video conferencing application, a user prompt for a virtual background in a video conference;
generate a first prompt from the user prompt, the first prompt including an instruction to create a second prompt based on the user prompt;
receive the second prompt from a text-to-text language model;
provide the second prompt as an input to an image generation model;
receive a generated image from the image generation model; and
apply the generated image as the virtual background.

7. The apparatus of claim 6, wherein the executable instructions include instructions that cause the at least one processor to:
initiate display of the generated image on the user interface;
detect a selection to the generated image; and
in response to the selection of the generated image being detected, apply the Generated image as the virtual background.

8. The apparatus of claim 6, wherein the generated image is a first generated image, wherein the executable instructions include instructions that cause the at least one processor to:
initiate display of a user interface including a data entry field for receiving the user prompt;
receive the first generated image and a second generated image from the image generation model;
initiate display of the first generated image and the second generated image on the user interface;
detect a selection to the first generated image; and
apply the first generated image as the virtual background.

9. The apparatus of claim 6, wherein the first prompt includes the user prompt and input conditional data.

10. The apparatus of claim 9, wherein the input conditional data includes display screen information.

11. The apparatus of claim 6, wherein the executable instructions include instructions that cause the at least one processor to:
generating a third prompt, the third prompt including the second prompt and input conditional data; and
transmitting the third prompt to the image generation model.

12. The apparatus of claim 11, wherein the input conditional data includes display screen information.

13. The apparatus of claim 6, wherein the image generation model includes a controllable diffusion model.

14. A method comprising:
receiving, via a user interface of a video conferencing application, a user prompt for a virtual background in a video conference;
generating a first prompt from the user prompt, the first prompt including an instruction to create a second prompt based on the user prompt;
receiving the second prompt from a text-to-text language model;
providing the second prompt as an input to an image generation model;
receiving a generated image from the image generation model; and
applying the generated image as the virtual background.

15. The method of claim 14, further comprising:
initiating display of the generated image on the user interface;
detecting a selection to the generated image; and
in response to the selection of the generated image being detected, applying the generated image as the virtual background.

16. The method of claim 14, wherein the generated image is a first generated image, the method further comprising:
initiating display of a user interface including a data entry field for receiving the user prompt;
receiving the first generated image and a second generated image from the image generation model;
initiating display of the first generated image and the second generated image on the user interface;
detecting a selection to the first generated image; and
applying the first generated image as the virtual background.

17. The method of claim 14, further comprising:
transmitting, over a network, the first prompt to the text-to-text language model.

18. The method of claim 14, further comprising:
transmitting, over a network, the second prompt to the image generation model.
